(19) United States
(12) Patent Application Publication
(10) Pub. No.: US 2009/0095694 A1
(43) Pub. Date: Apr. 16, 2009

(54) REDUCING TANNIN STAINING IN WOOD PLASTIC COMPOSITE MATERIALS

(76) Inventor: Edward F. Owens, Ellicott City, MD (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/870,771

(22) Filed: Oct. 11, 2007

(51) Int. Cl. B01D 21/26

(52) U.S. Cl. 210/787

(57) ABSTRACT

A process for reducing or eliminating tannins in wood flour so to reduce the level of tannins in wood/plastic composites made with the wood flour, and improve the finish provided by these products when in use. The process involves taking a precursor comprised of wood flour, dry wood waste or green wood waste, all of which contain high levels of tannin, rinsing the precursor with a solvent such as acetone, water or a base solution including Sodium Hydroxide (NaOH) or other salts, and heating the resultant mixture to a predetermined elevated temperature. The tannins in the mixture are rinsed out of the mixture with the solution out, with the remaining material which containing only a very slight amount of tannins. The remaining material is next dried, and then separated from the drying air stream through a cyclone or filter receiver. The material is then stored in bulk for delivery to a manufacturer of wood/plastic composites, an animal fur processor, or processed further into a finer wood flour.

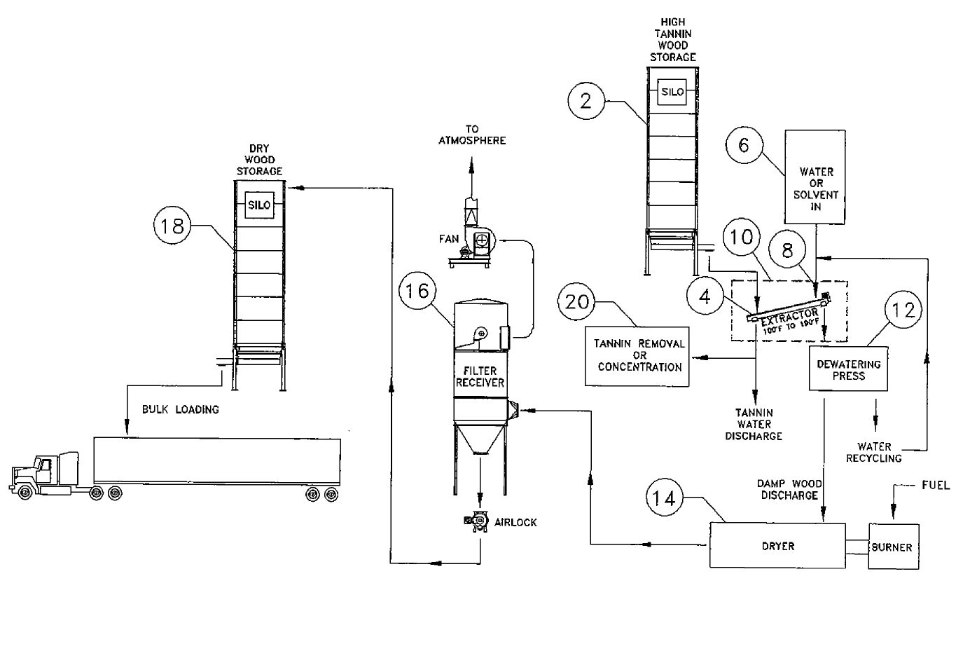

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates to the production of wood flour; and more particularly to the production of wood flour containing reduced or no wood tannin content.

Wood flour has a variety of uses. One of these is in the manufacturer of wood/plastic composite materials such as are used in wood decking, for example; while another use is in the processing of animal fur. With respect to the former application, it has become commonplace to use wood plastic composite materials in the construction industry. Wood plastic composites are resistant to weather and require less maintenance when used in a decking application. This is because they do not produce splinters or require staining or painting. Wood composite materials can also be readily used in environments where wood otherwise tends to deteriorate relatively quickly because of exposure to the elements.

Wood flour is generally composed of recycled wood by-products such as sawdust and wood chips from other wood manufacturing operations. Since these wood by-products contain tannins, the resultant wood/plastic composite materials also contain tannins. It is a drawback with these composite materials that, under certain conditions of their use, the tannins in them leach to the surface of the composite material and produce undesirable and unsightly stains or blemishes on the surface of the material. For example, in processing animal furs, wood flour is used to absorb oils from the furs. If the wood flour contains tannins, it can cause dark spots on the hides, substantially reducing the value of the processed fur.

The problem with tannins in wood flour has been recognized in the art, and attempts have been previously made to address it. See, for example, U.S. Pat. Nos. 7,145,031, 6,533,856, and 5,417,888, as well as the printed publication US 2004/0187221.

An alternate approach to tannin removal, used by some manufacturers of wood flour, has been to substitute sources of low tannin wood by-products or wood waste for the by-products having higher levels of tannin. These manufacturers will, for example, try to use by-products from maple trees, pine trees, and other low tannin species of trees instead of by-products from oak trees. This is because the former species typically contain lower levels of tannins than the latter. However, these wood flours are more expensive to produce as compared to the cost of oak based wood flour. The reason for this is that fewer maple trees are processed as compared to the number of oak trees, so the availability of their by-products for use in manufacturing wood flour is usually very limited, which significantly impacts the cost of manufacturing maple or pine based wood flour. For example, oak based wood flour can be produced about 20% faster than a maple based wood flour, and 100% faster than a pine based wood flour, for wood flours of comparable particle sizes

The present invention is directed to a process for reducing or eliminating tannins in wood flour so when wood flour is used in making the composite materials, their overall lower content of tannin results in a better and more sustainable finish appearance than that currently achieved. In addition, the process of the present invention allows the improved wood flour to be made in a cost effective manner.

### BRIEF SUMMARY OF THE INVENTION

The present disclosure is directed to a process for reducing or eliminating tannins in wood flour so to reduce the level of tannins in wood plastic composite products and improve the finish obtained using these products. The process involves taking a precursor comprised of wood flour, dry wood waste or green wood waste, all of which may contain high levels of tannin, rinsing it with a solvent such as acetone, water or an aqueous base solution including Sodium Hydroxide (NaOH) or other salts, and heating the resultant mixture to a predetermined elevated temperature. The tannins in the mixture are rinsed from the wood and drawn off with the solvent solution. The remaining material now contains only a very slight amount of tannins. This remaining material is now dewatered by means of pressing or spinning, and it is then dried. Wood flour is then separated from an air stream of the dryer using a filter/receiver (bag house). The resulting wood flour is then stored in bulk for delivery to a manufacturer of wood composites or an animal fur processor.

The tannin removed in accordance with the process can be concentrated and sold as tannin to other customers.

Other objects and features will be in part apparent and in part pointed out hereafter.

### BRIEF DESCRIPTION OF THE SEVERAL VIEWS OF THE DRAWINGS

The sole FIGURE of the drawings illustrates the process of the invention for producing wood flour with low levels of tannins.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawing, a wood flour precursor includes a wood flour, dry wood waste, green wood waste, or a combination of these ingredients. The wood flour or wood waste materials forming the precursor each comprise saw dust or wood chips of various sizes. Accordingly, the precursor comprises a fluent material which is stored in a container 2 such as a silo or vat. The tannin content of the precursor stored in the container is typically high because the wood or wood by-products are mostly from other wood manufacturers and they can contain varying amounts of several wood species such as oak, walnut, cherry, hickory, etc., that have a high tannin content.

The precursor is drawn from container 2 and deposited in an extractor 4 where it is mixed with a solvent from a container or vat 6. The solvent flows through the extractor in the opposite direction to the precursor to maximize the efficiency of the tannin removal. The solvent enters the extractor at an inlet 8 near the wood flour discharge. The solvent comprises acetone, water which is heated, or water mixed with Sodium Hydroxide (NaOH) or other salts, so that the resultant solution is a base solution. As the resultant mixture moves through extractor 4, the solvent solution is rinsed from the mixture removing tannins with it.

Extractor 4 moves the mixture of the precursor and solvent through a chamber or heating zone 10 in which the temperature is elevated to a predetermined level above room temperature. The temperature in the chamber or heating zone is on the order of, for example, 100° F.-190° F. (37° C.-87°). Because of the elevated temperature helps to speed up the extraction process, the solvent, which has dissolved the tannins in the precursor material, is drawn off, taking the tannins with it. By heating the mixture simultaneously with the rinsing operation, the amount of tannins removed from the wood fiber is significantly increased. As a result, when the mixture reaches the end of extractor 4, all, or substantially all, of the tannin content of the material has leached out from the mixture.

At the end of the extractor, the dampened material in the extractor falls out of the extractor into a dewatering press or centrifuge 12 where most of any solution remaining in the mixture is mechanically removed from the material. The damp wood discharge from dewatering press or centrifuge 12 is deposited into a dryer 14 where it is dried. Once it has dried, the moisture content of the material is less than approximately 10%, and preferably in the range of 5%-6%.

From dryer 14, the material is delivered to a cyclone or filter/receiver 16 where wood flour is separated from the dryer's air stream.

From filter 16, the resultant wood flour, which is a fluent material, is delivered to a container 18 for storage and subsequent bulk transfer to a user of the wood flour to make composite wood materials, process fur hides, or other applications. If the process is done on larger wood chips or green wood waste the material in container 18 is sent for further processing into wood flour by grinding and sifting.

Meanwhile, the tannins which are extracted from, the mixture, as described above, are delivered to a processor 20 where the tannins are concentrated into a bulk mixture, or dried to a powder, for delivery to users of tannins in other applications.

In view of the above, it will be seen that the several objects and advantages of the present disclosure have been achieved and other advantageous results have been obtained.

Having thus described the invention, what is claimed and desired to be secured by Letters Patent is:

1. A process for reducing or eliminating tannins in a wood flour used in manufacturing a composite wood product so to improve the surface finish of the product when used, comprising:
adding a solvent solution to a precursor containing a relatively high tannin content;
rinsing the resultant mixture to extract the solvent solution from the mixture, tannins in the precursor being removed from the mixture with the solvent solution;
running the remaining precursor material through a press or centrifuge to further remove the solvent solution, together with the tannins, to further reduce the tannin content; and,
drying the remaining precursor material to produce the wood flour used in manufacturing the composite wood product or to process animal furs.

2. The process of claim 1 further including simultaneously heating the mixture during the rinsing of the solvent solution from it, to speed up the transfer of the tannins from the precursor to the solvent solution, so the remaining precursor material has a significantly reduced tannin content.

3. The process of claim 1 further including storing the dried wood flour for subsequent transport to a manufacturer of the composite wood product.

4. The process of claim 3 further including accumulating the tannin removed from the precursor for use in other applications.

5. The process of claim 1 in which the precursor comprises a wood flour, dry wood waste or green wood waste, or a combination thereof, the wood flour, dry wood waste or green wood waste all containing relatively high levels of tannin.

6. The process of claim 1 in which the solvent solution comprises an acetone, water, or a base solution including Sodium Hydroxide dissolved in water.

7. The process of claim 6 in which the base solution includes one or more salts dissolved in water.

8. The process of claim 1 in which, after drying, the wood flour precursor has a moisture content which is less than approximately 10%.

9. The process of claim 8 in which the moisture content is preferably in the range of 5%-6%.

10. A method of producing a wood flour used in manufacturing composite wood products or processing animal hides, the wood flour having a relatively low tannin content, comprising:
adding a solvent solution to a precursor containing a relatively high tannin content;
rinsing the resultant mixture to extract the solvent solution from the mixture, tannins in the precursor being removed from the mixture with the solvent solution;
simultaneously with the rinsing step, heating the mixture to speed up the transfer of the tannins from the precursor to the solvent solution, so the remaining precursor material, after rinsing, has a significantly reduced tannin content
running the remaining precursor material through a press or centrifuge to further remove the solvent solution, together with the tannins, to further reduce the tannin content; and,
drying the remaining precursor material to produce the wood flour used in manufacturing the composite wood product or to process animal furs.

11. The method of claim 10 further including storing the dried wood flour for subsequent transport to a manufacturer of the composite wood product.

12. The method of claim 11 further including accumulating the tannin removed from the precursor for use in other applications.

13. The method of claim 10 in which the precursor comprises a wood flour, dry wood waste or green wood waste, or a combination thereof, the wood flour, dry wood waste or green wood waste all containing relatively high levels of tannin.

14. The method of claim 13 in which the solvent solution comprises an acetone, water, or a base solution including Sodium Hydroxide dissolved in water.

15. The method of claim 14 in which the base solution includes one or more salts dissolved in water.

16. The method of claim 10 in which, after drying, the wood flour precursor has a moisture content which is less than approximately 10%.

17. The method of claim 16 in which the moisture content is preferably in the range of 5%-6%.
